(19) United States
(12) Patent Application Publication
(10) Pub. No.: US 2008/0282994 A1
(43) Pub. Date: Nov. 20, 2008

(54) Animal Control Device and Method Of Use Thereof

(76) Inventor: John Nuno Martin, Spring Valley, CA (US)

Correspondence Address: John Nuno Martin, 3772 Helix Street, Spring Valley, CA, 91977, US

(21) Appl. No.: 12/121,773

(22) Filed: May 15, 2008

Related U.S. Application Data
(60) Provisional application No. 60/938,176, filed on May 15, 2007.

(51) Int. Cl. A01K 1/00; A01K 1/04; A01K 27/00

(52) U.S. Cl. 119/795; 119/769; 119/792

(57) ABSTRACT

A new animal control device and method of use thereof that generally comprises a main lead device, a movement inhibiting device, and a multitude of attachment clasps and or rings, whereby the lead has first and second attachment ends with the first attachment end being removably attached or connected to a collar device that is worn by an animal, such as a dog or cat, and the second attachment end being removably attached or connected to the movement inhibiting device that may be in the shape of a sphere or other shape, that will act to inhibit the movement or running of an animal, and which will also serve as a training tool for conditioning an animal such as a dog or cat, to obey commands, walk as directed, and not run away, while wearing the invention.

This application claims the prior filing benefit of provisional patent application #60938176 filed on May 15 2007.

### BACKGROUND OF THE INVENTION

### FIELD OF THE INVENTION

This invention relates generally to the field of devices for animal control. Moreover it pertains specifically to an animal control device and method of use thereof that will allow a user to control an animal in a hands free manner without holding on to the apparatus or attaching the apparatus to another object.

### SUMMARY OF THE INVENTION

In view of the limitations now present in the prior art, the present invention provides a new and useful animal control device and method of use thereof, which is simpler in operation, more universally usable and more versatile in application than known device of this kind.

The purpose of the present invention is to provide a new animal control device and method of use thereof that will allow the owner or trainer of an animal to control and or restrict the movements of the animal in a hands free manner without holding on to the apparatus or attaching the apparatus to another object. It is also a purpose of the present invention to provide a new animal control device and method of use thereof that has many novel features not offered by the prior art apparatus that result in a new animal control device and method of use thereof which is not apparent, obvious, or suggested, either directly or indirectly by any of the prior art apparatus.

The present invention in the preferred embodiment generally comprises a main lead device, a movement inhibiting device, and a multitude of attachment clasps and or rings, whereby the lead has first and second attachment ends with the first attachment end being removably attached or connected to a collar device that is worn by an animal, such as a dog or cat, and the second attachment end being removably attached or connected to the movement inhibiting device. The lead device may be offered in a variety of lengths and embodiments, including but not limited in use to, a cable, chain, rope, strap, or other embodiment which performs the same function and is to be considered apparent and obvious to the disclosure, with the lead further having adjustability features which allow a user to lengthen or shorten the lead as required. The movement inhibiting device, in the preferred embodiment, is a solid or inflatable sphere shaped object that attaches to the second attachment end of the lead device by means of a clip, clasp, Velcro fastener, or other fastener not referred to herein which performs the same function. The movement inhibiting sphere has a swivel connector which allows it to rotate or roll at the end of the lead without twisting or otherwise entangling the lead.

It is to be understood that the present invention in an alternate embodiment may comprise a movement inhibiting device that may be embodied in a variety of different shapes and sizes including but not limited in use to, a cube, hexagon, octagon, triangle, tube or cylinder, bar, or other shape not referred to here which performs the same function as the preferred embodiment and is to therefore be considered apparent and obvious to the disclosure. The movement inhibiting device may also be offered in a variety of sizes to suit the needs of a pet owner, the size of the animal being controlled or trained, or to correspond to the various stages of training which utilize a diminishing sized movement inhibiting device as the training progresses.

Additionally, the training process may progress to a point that utilizes, or the animal may only require, a movement inhibiting device that is the equivalent of a small ball or other object that is approximately the size of the clasp at the second attachment end of the lead, whereby the use of the small object or even the lead alone, will constitute enough of a movement inhibiting presence to control or prevent excessive movement by the animal.

It is to be further understood that an alternate embodiment of the present invention may also comprise a retractable lead device that is housed within the sphere or otherwise shaped movement inhibiting device, whereby the user would have access to the interior of the movement inhibiting device by means of a flap or opening in the device, whereby the user can insert a hand to grab, hold, and or operate the retractable lead device. The retractable lead device in one embodiment may be built into the movement inhibiting device at the manufacturing stage, or the invention may be offered so as to provide the user with the option of adding an after market retractable lead device to the invention after purchase.

Another alternate embodiment of the present invention disclosed herein embodies a handle device built into the movement inhibiting device, whereby the user is able to grab onto and control the animal by means of the handle device being connected to the lead device.

It is to be understood that the handle may be embodied in a variety of shapes or forms including but not limited to, a hoop or ring, a pistol grip, a knob, a shaft or pole, a series of finger rings, a strap or loop of material, and other handle embodiments not referred to herein which perform the same function and are to be considered apparent and obvious to the disclosure.

The present invention is intended to be used for the purpose of inhibiting an animal's movement without securing or tying down the animal. It allows the animal to move freely about an open or enclosed area such as a patio, yard etc., without being tied to an object in one specific spot or section, while being prevented from leaving the area by way of an opening through or under a fence or gate.

The movement inhibiting device will act to make contact with the animal's front legs when utilized in a shortened lead embodiment, thereby taking the animal out of the jumping or climbing mindset. Additionally, the present invention allows the animal to move freely in an open area such as a front yard, street, park, beach etc., but not escape its' handler ultimate control by running away. The lead and movement inhibiting sphere by weight, impediment of stride or becoming entwined with a stationary object will allow the handler or another person to reestablish physical control of the animal with relative ease.

The animal can be trained to “go on a semi-controlled walk” with its' handler. A combination of physical control (holding on to the sphere) and free walking with the movement inhibiting sphere will condition the animal to stay close to the handler and follow commands. The training process may also utilize movement inhibiting devices of diminishing size and weight that corresponds to the success of the training process. As an animal becomes more conditioned or trained in its behavior, the necessity of the movement inhibiting device, and therefore the need for size and weight in the movement inhibiting device, will diminish.

It is intended that the ball component of the present invention disclosed herein be manufactured out of materials such as leather, synthetic leather, or other materials which are suitable for the manufacture of a durable ball. The lead component is to be manufactured out of a suitable cable material having a durable plastic sleeve or outer coating to protect the animal from direct contact with the cable.

An alternate embodiment of the present invention disclosed herein may be manufactured wherein the movement inhibiting device comprises an adjustable tension activated lead release mechanism that will disconnect the lead from the ball when a specific amount of tension is applied to the device, thereby preventing the animal from hanging if the animal jumped over a fence and the device were to become caught on the fence top.

The foregoing has outlined, in general, the physical aspects of the invention and is to serve as an aid to better understanding the intended use and application of the invention. In reference to such, there is to be a clear understanding that the present invention is not limited to the method or detail of construction, fabrication, material, or application of use described and illustrated herein. Any other variation of fabrication, use, or application should be considered apparent as an alternative embodiment of the present invention.

### OBJECTIVES OF THE INVENTION

### Accordingly Several Advantages and Objects of the Present Invention are:

A principal objective of the present invention is to provide an Animal Control Device and Method of Use Thereof that will overcome the deficiencies of the prior art devices.

An objective of the present invention is to provide an Animal Control Device and Method of Use Thereof that will allow an animal to move freely about an environment while maintaining limitations on overall movement.

Another objective of the present invention is to provide an Animal Control Device and Method of Use Thereof that allows a user to train an animal such as a dog or cat in a hands free manner to stay close or not run away by limiting the animal's movement ability.

Another objective of the present invention is to provide an Animal Control Device and Method of Use Thereof that utilizes a movement inhibiting device to limit or stop an animal's movement if they attempt to run away.

Another objective of the present invention is to provide an Animal Control Device and Method of Use Thereof that will prevent animals from crawling under or through openings, such as those in a fence or enclosure.

Another objective of the present invention is to provide an Animal Control Device and Method of Use Thereof that can be offered in a variety of shapes and sizes to suit a user's control or training needs or to accommodate the size of an animal.

Another objective of the present invention is to provide an Animal Control Device and Method of Use Thereof that can incorporate a retractable lead device within the movement inhibiting device.

Another objective of the present invention is to provide an Animal Control Device and Method of Use Thereof that allows a user to control an animal by handle or grip embodied within the movement inhibiting device as with a leash.

Another objective of the present invention is to provide an Animal Control Device and Method of Use Thereof that can be used as a training tool and process that utilizes diminishing sizes of movement inhibiting devices that correspond to the training progress of the animal.

Another objective of the present invention is to provide an Animal Control Device and Method of Use Thereof that can be used to control or inhibit the movement of a variety of different animals such as dogs, cats, goats, pigs, and other animals not referred to herein which would benefit from the use of the device.

Another objective of the present invention is to provide an Animal Control Device and Method of Use Thereof that comprises an adjustable tension activated lead release mechanism that will disconnect the lead from the ball when a specific amount of tension is applied to the device, thereby preventing the animal from hanging if the animal jumped over a fence and the device were to become caught on the fence top.

Another objective of the present invention is to provide an Animal Control Device and Method of Use Thereof which is more versatile and compact than prior art devices.

It is intended that any other advantages and objectives of the present invention that become apparent or obvious from the detailed description or illustrations contained herein are within the scope of the present invention.

### BRIEF DESCRIPTION OF THE DRAWINGS

FIG. 1. is a side view of an Animal Control Device according to the present invention. Illustrating the invention in use attached to a dog, and also showing the invention embodied with a sphere shaped movement inhibiting device.

FIG. 2. is a side view of an Animal Control Device according to the present invention. Illustrating the invention embodied with a sphere shaped movement inhibiting device(112) attached to a dog(117), and further showing the device preventing the dog from running away after crawling through an opening(119) under a fence(120).

FIG. 3. is another side view of an Animal Control Device according to the present invention. Illustrating the invention in use, attached to a dog(117) with the invention embodied with a sphere shaped movement inhibiting device(112) attached to the lead(111) which is attached to the dogs collar(116) by means of the fastening rings and hardware(113). This image also illustrates the device making contact with the dog's rear leg and thereby limiting the dog's motion.

FIG. 4. is a side view of an alternate embodiment of an Animal Control Device according to the present invention. Illustrating the invention embodied with a smaller sphere shaped movement inhibiting device(112) and attached to a dog(117), with a person holding the lead(111) in the same manner as they would a leash.

FIG. 5. is a perspective view of an Animal Control Device according to the present invention. Illustrating the invention embodied with a sphere shaped movement inhibiting device(112) attached to a lead(111), also showing the flexibility of the lead device(111).

FIG. 6. is a perspective view of an Animal Control Device according to the present invention. Illustrating the invention embodied with a sphere shaped movement inhibiting device(112) having an attached lead(111) and fastening hardware(113).

FIG. 6. is a perspective view of an Animal Control Device according to the present invention. Illustrating the invention embodied with a sphere shaped movement inhibiting device(112) that further contains a built in retractable lead device accessible through an access flap panel(121).

FIG. 7. is a perspective view of an Animal Control Device according to the present invention. Illustrating the invention embodied with a sphere shaped movement inhibiting device(112) that further contains a built in retractable lead device(122) accessible through an opening(123) in the sphere.

FIG. 8. is a perspective view of multiple alternate embodiments of an Animal Control Device according to the present invention. Illustrating the invention embodied with a small sphere shaped movement inhibiting device(112) attached to a short lead(124) as well as a longer lead(125).

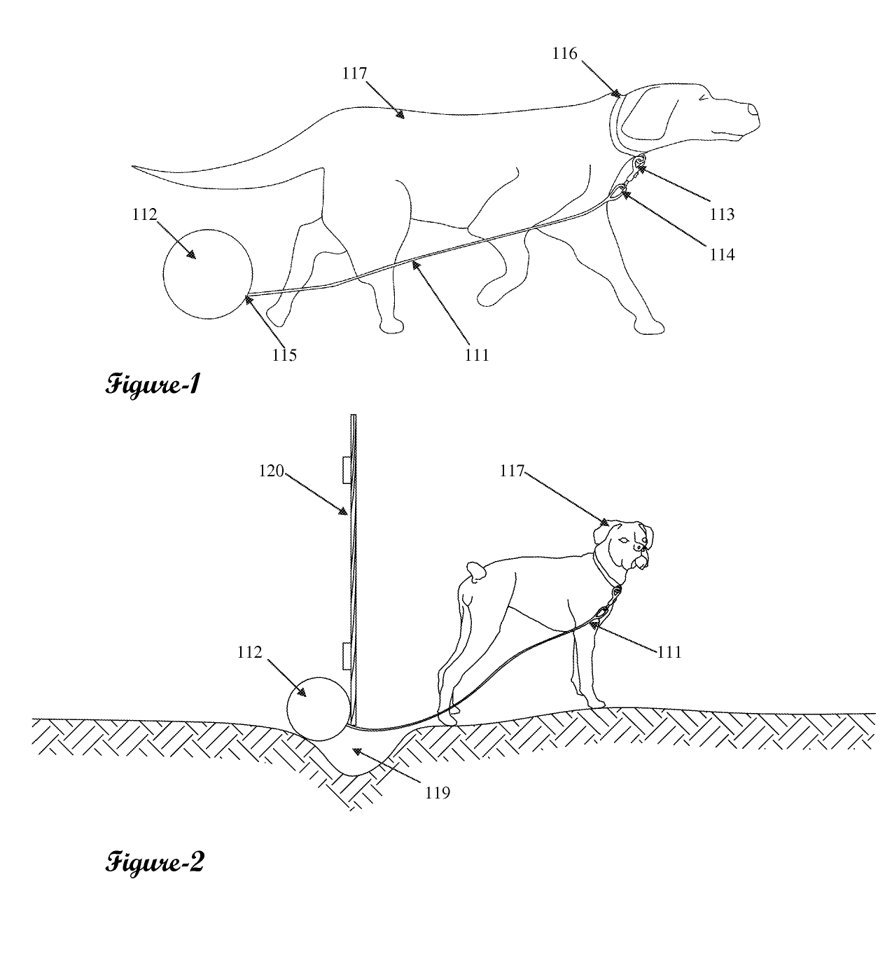

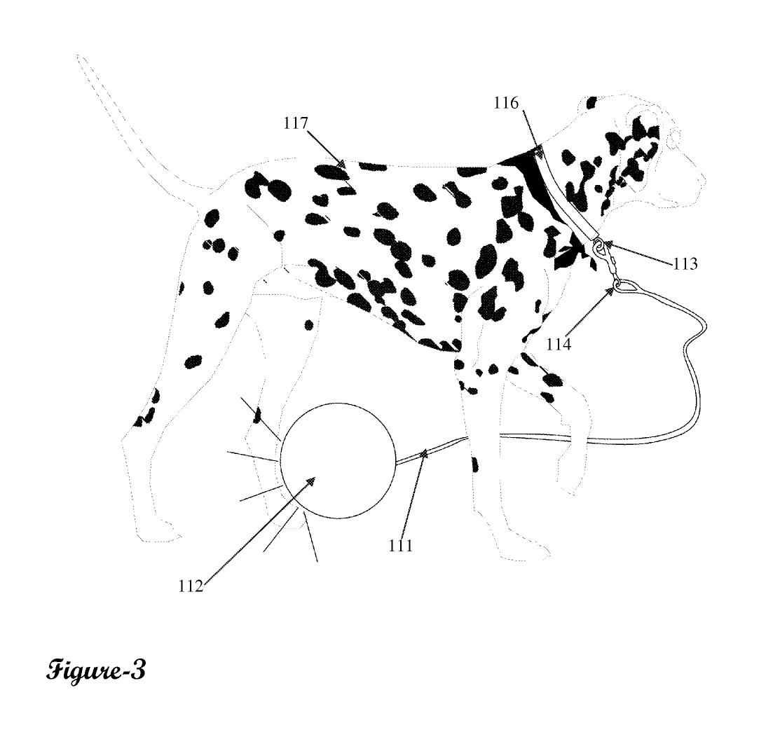

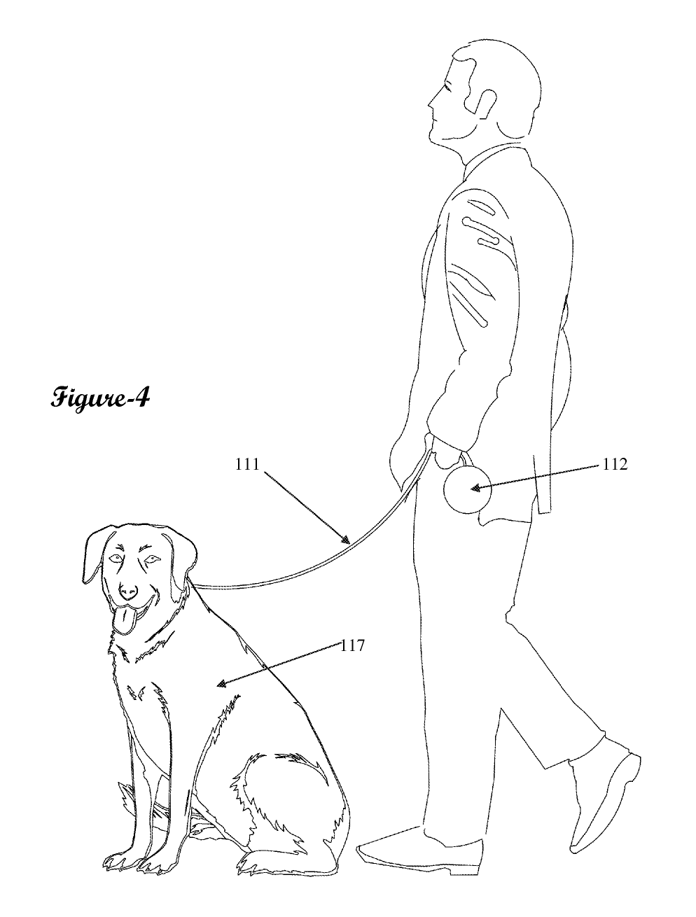

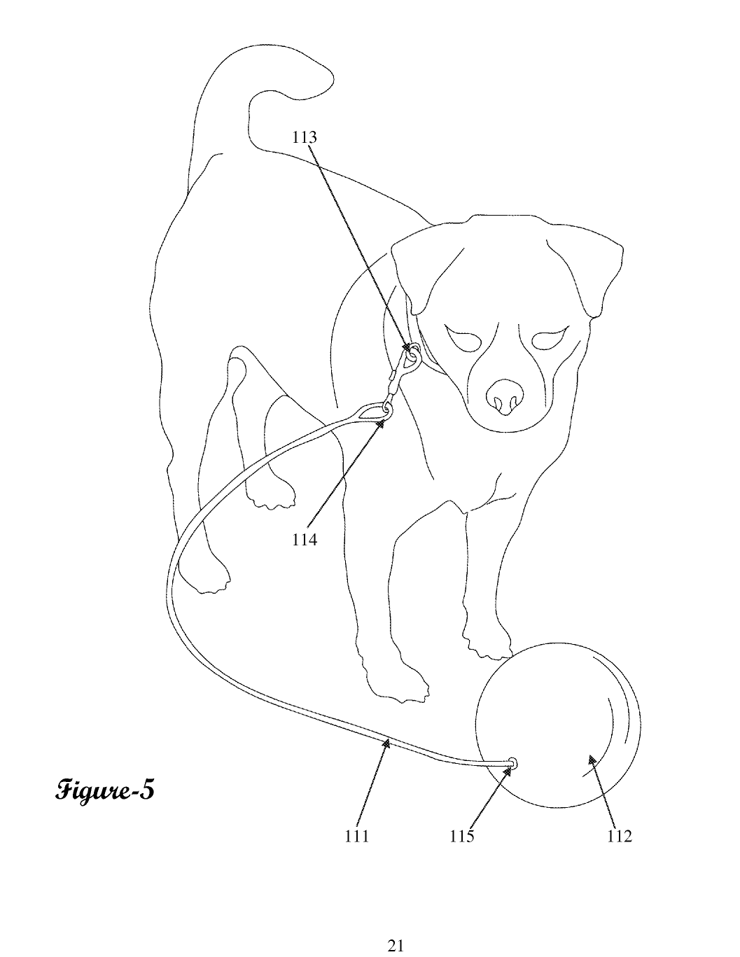

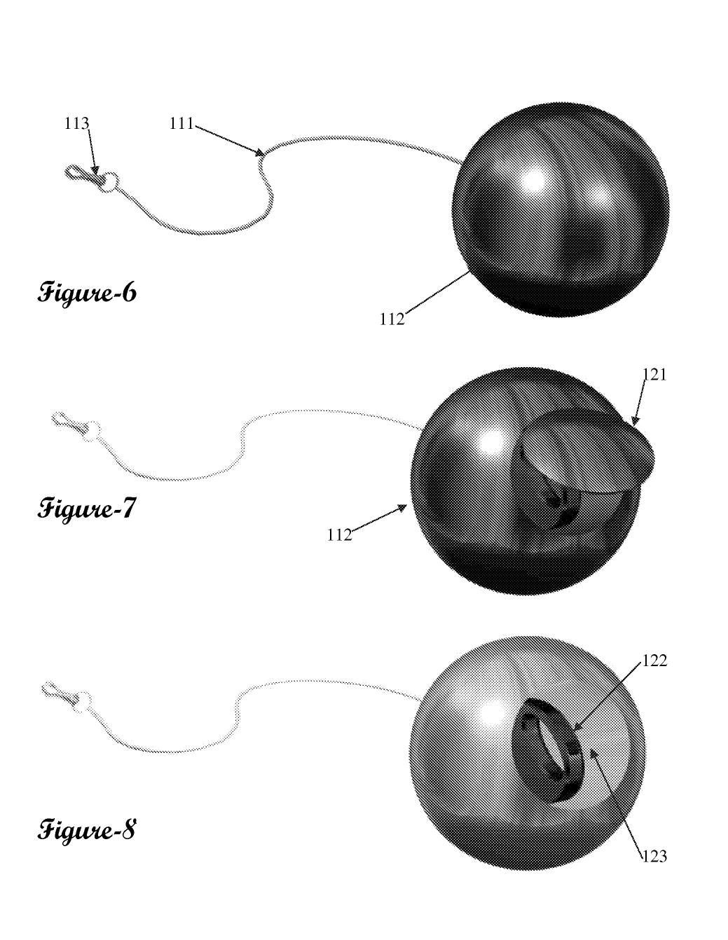

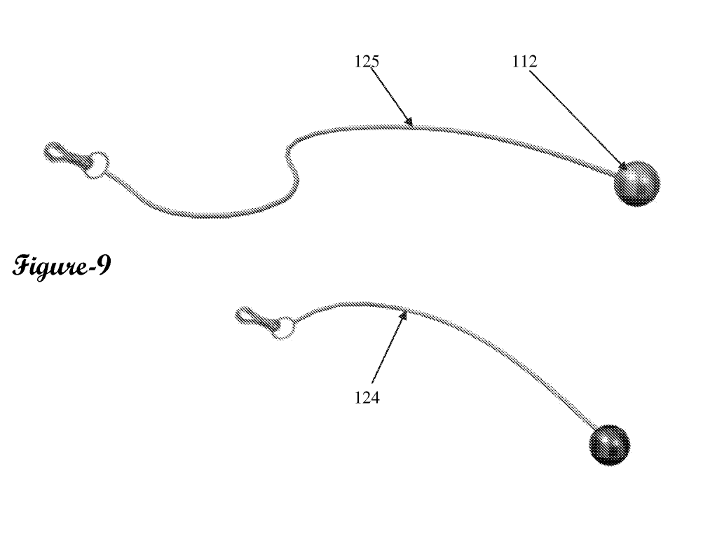

### DETAILED DESCRIPTION OF THE INVENTION

The present invention(110) in the preferred embodiment generally comprises a main lead device(111), a ball shaped movement inhibiting device(112), and a multitude of attachment clasps and or rings(113), whereby the lead(111) has first(114) and second(115) attachment ends with the first attachment end(114) being removably attached or connected, by means of a multitude of attachment clasps and or rings(113), to a collar device(116) that is worn by an animal(117), such as a dog or cat, and the second attachment end(115) being removably attached or connected to the ball shaped movement inhibiting device(112) and thereby acting to limit the movement of the animal(117) as well as inhibiting the animal from successfully crawling through openings(119) such as that found in or under a yard enclosure fence (120).

I claim:

1. An animal control device and method of use thereof that comprises a main lead device, a movement inhibiting device, and a multitude of attachment clasps and or rings, whereby the lead has first and second attachment ends with the first attachment end being removably attached or connected to a collar device that is worn by an animal, and the second attachment end being removably attached to the movement inhibiting device.

2. The apparatus of claim 1 wherein the movement inhibiting device is sphere shaped.

3. The apparatus of claim 1 wherein the movement inhibiting device is bone shaped for increased movement inhibiting.

4. The apparatus of claim 1 wherein the movement inhibiting device comprises an adjustable tension activated lead release mechanism.

5. The apparatus of claim 1 wherein the movement inhibiting device comprises a handheld, lead retracting device.

6. The apparatus of claim 1 wherein the movement inhibiting device comprises a GPS or Global Positioning System locating device.

7. The apparatus of claim 1 wherein the movement inhibiting device comprises a swivel attachment allowing for free spin movement of the movement inhibiting device.

8. An animal training apparatus comprised of a ball connected to a length of cable, and fasteners for attaching the apparatus to a dog's collar and thereby inhibit the running motion of the dog.

9. An animal training apparatus comprised of a ball connected to a length of cable, and fasteners for attaching the apparatus to a dog's collar wherein the size of the ball will restrict the size of an opening through which the dog is allowed to pass.

10. An animal control device and method of use thereof that comprises a main lead device, a plurality of movement inhibiting device of varied sizes, and a multitude of attachment clasps and or rings, whereby the lead has first and second attachment ends with the first attachment end being removably attached or connected to a collar device that is worn by an animal, and the second attachment end being removably attached to one of the movement inhibiting device, whereby the user can alternate or change the movement inhibiting device for animal training purposes.
